(19) United States
(12) Patent Application Publication
(10) Pub. No.: US 2026/0350875 A1
(43) Pub. Date: Nov. 5, 2026

(54) ENHANCING EDITABILITY OF GENERATED VECTOR GRAPHICS

(71) Applicant: Adobe Inc., San Jose, CA (US)

(72) Inventors: Kush Pandey, Uttar Pradesh (IN); Tarun Beri, Uttar Pradesh (IN); Avinash Kumar, Uttar Pradesh (IN); Ankit Prabhakar Deogirikar, Karnataka (IN)

(21) Appl. No.: 19/196,267

(22) Filed: May 1, 2025

(51) Int. Cl. G06T 11/60; G06T 11/23; G06T 11/40

(52) U.S. Cl. CPC G06T 11/60; G06T 11/23; G06T 11/40; G06T 2210/12

(57) ABSTRACT

Techniques for enhancing the editability of generated vector graphics are provided. In an example method, a processing device receives an image. The method further includes determining one or more regions of the image. The method further includes classifying each region as a stroke or a fill by determining a characteristic axis of the region. The method further includes generating a spatial data structure representing the regions classified as strokes using a characteristic axis of each stroke. The method further includes determining pairs of overlapping strokes and fills. The method further includes identifying, using the pairs of overlapping strokes and fills and the spatial data structure, at least one associated stroke-fill pair. The method further includes determining a layer ordering of the at least one associated stroke-fill pair. The method further includes generating a vector graphic using the at least one associated stroke-fill pair according to the layer ordering.

### TECHNICAL FIELD

This disclosure generally relates to vector graphics and, more specifically, to techniques for enhancing editability of generated vector graphics.

### BACKGROUND

Vector graphics are widely used in fields such as digital design, illustration, and animation. Unlike raster images or bitmaps, vector graphics represent images through mathematically defined paths, using points, lines, curves, and shapes. Designers can easily modify individual elements by adjusting paths, colors, and by applying transformations. Because vector graphics are based on mathematical primitives, they maintain high-fidelity rendering at any resolution or scale.

Essential to this functionality of vector graphics is effective editability. An editable vector graphic that is most useful to a designer includes elements with well-defined and consistent boundaries and fills that can be independently adjusted. This capability relies on a clear, understandable structural definition of the various vector graphic components, which enables designers to modify elements while preserving the integrity of the overall design. For example, an editable vector graphic consists of distinct elements, each with its own intuitive boundary and structure. This allows for modifications to dimensions, colors, or shapes of individual elements without unintended effects on others. Some existing tools can be used to convert raster images such as images output by generative artificial intelligence (“AI”) tools into vector graphics. However, such tools may output vector graphics that lack the structural completeness and editable boundaries needed for practical design applications.

### SUMMARY

Embodiments described herein relate to enhancing the editability of generated vector graphics. In one example process that may be implemented using a computing system, a raster image, such as an image generated using a generative AI tool, is analyzed to determine one or more regions of the image and classify each region of the one or more regions as a stroke or a fill. Regions are classified as stroke or fill based on a characteristic axis determined for the region. A spatial data structure is then generated representing the regions classified as strokes using the characteristic axis of each stroke. One or more pairs of overlapping strokes and fills are then determined. The one or more pairs of overlapping strokes and fills and the spatial data structure are used to identify associated stroke-fill pairs. A layer or z-ordering of the associated stroke-fill pairs is determined. A vector graphic is then generated using the associated stroke-fill pairs according to the layer ordering.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a diagram of an example system for enhancing editability of generated vector graphics, according to some aspects of the present disclosure.

FIG. 2 is a flow diagram of an example process for enhancing the editability of generated vector graphics, according to some aspects of the present disclosure.

FIG. 3 shows an example of optimal ridge detection, according to some aspects of the present disclosure.

FIGS. 4A and 4B show example schematic representations of bounding boxes around strokes and fills, according to some aspects of the present disclosure.

FIG. 5 is a flow diagram of an example process for using the one or more pairs of overlapping strokes and fills and the spatial data structure, at least one associated stroke-fill pair, according to some aspects of the present disclosure.

FIG. 6 shows illustrations of associating stroke and fill pairs, according to some aspects of the present disclosure.

FIGS. 7A-7B shows an example of a compound path, according to some aspects of the present disclosure.

FIG. 8 shows an example of generating continuous stroked using unassociated strokes, according to some aspects of the present disclosure.

### DETAILED DESCRIPTION

Vector-based imagery, known for its accuracy and scalability, is extensively employed in digital art, illustration, and animation. Unlike bitmap or raster graphics, which rely on pixel grids, vector graphics are constructed from mathematically defined curves and lines. This approach grants designers precise control over individual elements, making modifications straightforward. A fundamental aspect of vector graphics is their editability: each vector graphic component's outline and fill can be altered independently. In conventional vector graphics workflows, every element within a design has its own defined boundaries and attributes that comport with designer expectations, allowing for independent modifications to paths, fills, or strokes without affecting surrounding elements.

Vector graphics can be composed of paths each of which are made up of a number of segments defined by pairs of anchor points. A path can define a shape through a series of connected points, which may be open or closed, and can be rendered with a stroke or a fill. A stroke can be, for example, a defined-width outline with various properties such as color, width, or style (solid, dashed, etc.). A fill may be a solid color, gradient, or pattern applied to an area enclosed by a closed path. Some vector graphics may have compound paths which include multiple paths combined using specific “fill rules.” A fill rule may be, for example, the even-odd rule, which determines visibility by counting path overlaps and filling only areas when the count is odd. Compound paths enable complex shapes that include cutouts, such as enclosed voids.

Some generative AI tools can be used for ideation and rapid prototyping of vector graphics. But existing solutions for converting raster images into vector graphics typically face significant limitations in editability, structural consistency, and preservation of artistic intent. These tools typically operate by converting textual prompts into vectorized imagery using a two-stage process. First, a diffusion model generates an image from a textual prompt. Then, tracing algorithms are used convert the resulting raster image into vector graphic format. These algorithms use technologies such as edge detection or color clustering to convert images into vector outlines, which are then filled with solid colors. Although effective for generating vector shapes, these methods often result in fragmented, unstructured output that lacks cohesive organization. Strokes and fills are typically handled as separate, unconnected paths, making it challenging for designers to edit the artwork meaningfully. Moreover, these algorithms do not capture the layered z-order or compound paths essential for creating depth and transparency, which results in static, less adaptable graphics. While this workflow may be effective for preliminary design exploration, it falls short of meeting professional designers'demands for editability, precision, and structural integrity that vector-based artwork requires for production work.

For example, consider a vector graphic of a simple object such as a rocket with three components (or component types): a head, a body, and one or more fins. Designers prefer that the rocket consists of separate yet cohesively structured components, such that each component can be independently edited or altered. However, existing solutions that convert raster images to vector graphics generate paths that lack these properties, often resulting in defects such as fragmented, overlapping strokes without a clear or editable boundary.

In the rocket example, existing solutions may generate largely un-editable geometry with no structural cohesiveness of individual elements or of the graphic as a whole. For example, stroke-type paths may be converted to fills as opposed to strokes with internal fills, requiring designers to edit fills and strokes separately or to manually combine them. Or, individual strokes may be fragmented, rather than continuous. Meaningful compound paths may not be created at all. Consequently, the use of AI-generated vector graphics is limited to ideation or rough sketches, significantly reducing their utility to designers and requiring vector graphics used in production to be manually generated or laboriously editing the strokes and fills generated using existing solutions.

The techniques for enhancing the editability of generated vector graphics as disclosed herein can be used to address these challenges. In an example method provided to introduce certain concepts, a computing system configured to generate editable vector graphics for designers receives an image, such as a raster image generated by a diffusion model based on a text prompt. For example, the diffusion model may be prompted to generate a “minimalist, simple rocket in vector style with black outlines and yellow fills.” The computing system can then determine one or more regions of the image using, for example, an image segmentation algorithm based on color boundaries, effectively dividing the image into colored regions. For example, identified regions of the rocket may include closed black lines that outline the body and fins of the rocket and yellow regions that fill in the body and fins.

The identified regions are then classified as either strokes or fill using a characteristic axis identified for each region. For example, regions with a well-defined, open characteristic axis that is close to the centerline of the region may be classified as strokes, while regions with diffuse or closed characteristic axes may be classified as fills. The closed black lines that outline the body of the rocket have a well-defined centerline that corresponds closely to the characteristic axis. In contrast, the yellow fill of the rocket body may have a characteristic axis that is a closed loop inside the body or one that extend throughout the body, having no well-defined centerline.

The computing system then generates a spatial data structure representing each stroke based on the characteristic axis, such as an R-tree. An R-tree, in this context, is a hierarchical data structure that partitions and indexes strokes based on their characteristic axes, which enables the computing system to “query” the spatial data structures to determine properties such as overlaps, intersections, proximities, containment, and so on. For example, given one stroke outlining a rocket fin and another stroke outlining another rocket fin, the computing system can query the R-tree to determine whether the two strokes intersect or are within a specified proximity, such as detecting if the fins are close together or overlapping.

The computing system next identifies pairs of overlapping strokes and fills by querying the spatial data structures in concert with other abstractions such as bounding boxes drawn around fills. The computing system can then identify at least one associated stroke-fill pair using a series of processes to determine if there is sufficient overlap between the boundary of a fill and an overlapping stroke. If the overlapping stroke appears to completely surround the fill, as determined using a series of operations and comparisons, the stroke-fill pair can be associated. For example, given a stroke outlining a rocket fin and the enclosed yellow fill, overlap between a bounding box of the fill and the outlining stroke first identifies the two as overlapping. Then, the pair can be associated by determining that the outlining stroke closely coincides with the edge of the fill.

Given the collection of associated stroke-fill pairs thus identified, the computing system can then determine the z-or layer-ordering of the associated stroke-fill pairs. For example, colors from each stroke-fill pair can be compared with the colors from the original raster image to determine a logical z-ordering for the associated stroke-fill pairs. For instance, if the stroke corresponding to the black outline of the rocket body and the stroke corresponding to the black outline of an attached fin overlap, the widest stroke that also corresponds to the original raster image can be selected as the topmost stroke.

Finally, the computing system generates a vector graphic using the collection of associated stroke-fill pairs according to the determined z-ordering. The components of the rocket including the rocket body and its attached fins are now editable strokes with associated fills, logically grouped and z-ordered, according to the expectations of the designer.

The techniques disclosed herein for implementing enhancing editability of generated vector graphics constitute improvements to the technical field of vector graphics generation and editing. The disclosed techniques address the limitations associated with using generative AI in creating production-ready, editable vector graphics. Unlike existing approaches which often produce fragmented, unstructured, or disjointed vector graphics, the techniques disclosed herein result in vector graphics with structural integrity, editability, and compatibility with professional design workflows. Processes such as image segmentation, stroke-fill pairing, and z-ordering can generate vector graphics with cohesive, logically grouped components that mirror the precision and flexibility of hand-crafted designs, enabling designers to independently edit individual elements without compromising the structural coherence of the overall composition.

These improvements are implemented through the elimination of stroke fragmentation, consolidation of paths for fills and strokes, and the improved representation of compound shapes, ensuring boundary integrity and realistic overlaps among identified elements. These improvements can enable designers to make global or localized adjustments effortlessly, maintaining alignment with familiar vector editing practices. Furthermore, the techniques extend the utility of generative AI beyond mere ideation, yielding fully editable and structurally sound vector graphics suitable for production work, enabling designers to integrate generative AI into their creative processes.

These illustrative examples are given to introduce the reader to the general subject matter discussed herein and the disclosure is not limited to these examples. The following sections describe various additional non-limiting examples of systems and methods for implementing enhancing editability of generated vector graphics.

### Overview

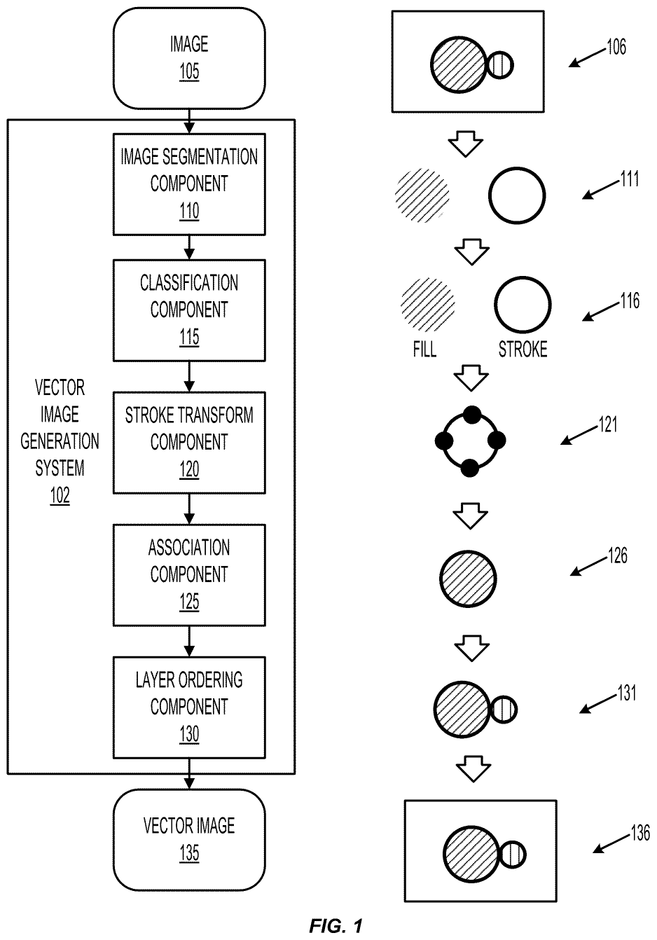

FIG. 1 is a diagram of an example system 102 for enhancing editability of generated vector graphics, according to some aspects of the present disclosure. FIG. 1 depicts a vector graphic generation system 102 alongside a series of example images 150 illustrating certain operations performed by the system 102. The vector graphic generation system 102 is shown as a standalone computing system, but may be, according to various examples, a component of a computing system or an application executed by a computing device such as a client device (e.g., smart phone, laptop, tablet, etc.). The vector graphic generation system 102 includes several components for generating vector graphics according to this disclosure. The components of the vector graphic generation system 102 may be implemented in hardware, software, or a combination thereof. Software components may be hosted on physical servers, virtual machines, cloud computing instances, or a combination thereof. The components of the vector graphic generation system 102 are shown in FIG. 1 grouped together for clarity, but in various examples may include numerous separate, communicatively coupled components.

Generation of a vector graphic with enhanced editability begins with receipt, by the vector graphic generation system 102, of an image 105. For example, a generative AI model such as a diffusion model can be used to generate the image 105 from a textual prompt. Existing approaches use, for example, conventional tracing algorithms to convert the image 105 into vector format. While such an approach may be effective for preliminary design exploration, it falls short of meeting professional designers'demands for editability, precision, and structural integrity that production vector-based artwork requires. An example input image of two circles with different shading is shown at 106.

The image 105 is received by an image segmentation component 110 that determines one or more regions of the image 105. Regions can be identified using, for example, color boundaries, similar to how designers intuitively differentiate strokes from fills in traditional artwork. Determining the one or more regions can thereby break down of the image into components. The example image at 106 is shown as two disparate regions at 111. These components can subsequently be classified into likely vector graphic components such as paths, strokes, and fills and characterized using the techniques of this disclosure to convert the image 105 into a vector graphic.

A classification component 115 classifies each region of the one or more regions as a stroke or a fill by determining a characteristic axis of the region. For example, a Euclidean distance transform technique such as optimal ridge detection (“ORD”) can be used to extract a “medial axis” for each region, which is one example of a characteristic axis that can be used according to various examples. The characteristic axis can function as a continuous ridge through each region accurately represented using branches and junctions. Each region can then be classified as a stroke or a fill according to certain characteristics of the characteristic axis. For example, if the characteristic axis closely parallels the centerline of a region, it is likely a stroke. At 116, the two disparate regions of 111 are labeled as a fill and a stroke, representing their classification.

The stroke transform component 120 generates a spatial data structure representing the regions classified as strokes, such as an R-tree data structure. An R-tree is a hierarchical spatial index that can be used for organizing geometric objects, such as strokes in a vector graphic, by storing their bounding boxes in a tree structure to enable efficient spatial queries such as overlap, intersection, nearest neighbor, and containment tests. Each stroke region's characteristic axis, or a representation thereof, can be added to the spatial data structure. At 121, the circle classified as a stroke is shown schematically with filled black circles representing a characteristic axis and its representation in a spatial data structure.

The association component 125 can be used to determine one or more pairs of overlapping strokes and fills and then identify at least one associated stroke-fill pair. In a simple example, an associated stroke-fill pair can refer to a fill that is completely bounded by a stroke, exemplified by the shaded circle shown with a black boundary at 126. In one example process for making this association, overlaps can first be identified by “querying” the spatial data structure using bounding boxes drawn around the regions classified as fills. Then, the association proceeds by examining a geometric intersection, among other comparisons, between overlapping pairs of strokes and fills. Strokes shared between multiple fills can be duplicated as needed.

Given a collection including at least one associated stroke-fill pair, numerous additional refinements are possible. For example, for paths that have multiple stroke layers, such as concentric rings or borders with varied stroke widths, the techniques disclosed herein can be used to identify these cases by examining “nested” stroke boundaries. In another example, “compound paths,” or paths that are combined according to certain rules to create a single entity, can be mapped by identifying enclosed regions and aligning them with surrounding fills. In yet another example, unpaired stroke segments that do not align with a fill can be mapped by analyzing junctions in the unaligned strokes and by ensuring continuity across unaligned stroke segments.

The layer ordering component 130 (sometimes equivalently referred to as z-ordering) determines a layer ordering of the at least one associated stroke-fill pair determined above to ensure that overlapping areas are layered in a sequence that provides enhanced editability for designers. For example, strokes or fills can be overlaid upon and matched with features of the input image 105 to determine a layer ordering that best preserves the appearance of the image 105.

The vector graphic generation system 102 can then generate a vector graphic using the at least one associated stroke-fill pair according to the determined layer ordering. For example, a rendering engine can be used to convert the information about the at least one associated stroke-fill and associated layer ordering into an editable vector graphic. Designers can then easily adjust stroke widths, colors, fills, and boundaries individually or collectively, without laborious manual intervention.

### Method for Enhancing the Editability of Generated Vector Graphics

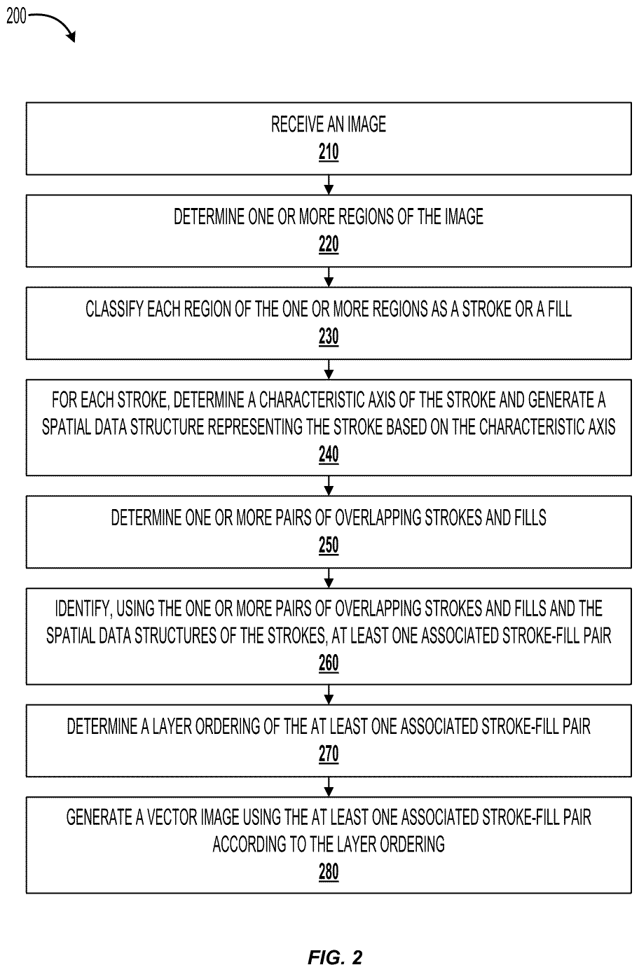

FIG. 2 is a flow diagram of an example process 200 for enhancing the editability of generated vector graphics, according to some aspects of the present disclosure. The process 200 depicted in FIG. 2 may be implemented in software executed by one or more processing units of a processing device, implemented in hardware, or implemented as a combination of software and hardware. This process 200 is intended to be illustrative and non-limiting. The example process herein is described with reference to the example vector graphic generation system 102 implementation depicted in FIG. 1, but other implementations are possible. Although FIG. 2 depicts various processing operations occurring in a particular order, the particular order depicted is not required. In certain alternative embodiments, the processing may be performed in a different order, some operations may be performed in parallel, or operations may be added, removed, or combined together.

At block 210, a computing system, such as the vector graphic generation system 102 of FIG. 1, receives an image. For example, the image may be a raster image or bitmap generated using a generative AI diffusion model such as Adobe's Firefly technology or other diffusion model architecture trained to iteratively refine noise into a coherent image based on a text prompt. The image may be received in a compressed image format such as PNG, JPEG, or WEBP, or in high-fidelity formats such as TIFF for applications requiring lossless quality.

At block 220, the computing system determines one or more regions of the image. For example, the input image can be segmented into distinguishable regions based on color differences using an image segmentation algorithm such as thresholding, clustering (e.g., k-means clustering), or region growing. In some examples, edge detection techniques can be applied to identify boundaries between adjacent regions with distinct pixel values. The image segmentation algorithm can be configured to mirror how designers use color variations to delineate different parts of a design (e.g., strokes and fills). The segmentation process can separate regions by analyzing noticeable changes in color, which suggests edges and boundaries. Each identified region is isolated and treated as a standalone element until further classified, as described next.

At block 230, the computing system classifies each region of the one or more regions as a stroke or a fill by determining a characteristic axis of the region. Classification of the one or more regions may involve, for example, comparing the characteristic axis of the region with other geometric characteristics of the region to determine whether the region is a stroke or fill. In some examples, determining the characteristic axis of the region may involve first converting the region to a monochrome color scheme. For example, each region may be transformed into a monochrome image where pixels within a region are a first color (e.g., white), while the background pixels are a second color (e.g., black). Then, the computing system can determine the characteristic axis of the region using a Euclidean distance transform.

The Euclidean distance transform may be, for example, an optimal ridge detection (“ORD”) and the characteristic axis of the region, in this case, is a medial axis of the stroke. ORD is one example of a Euclidean distance transform that can be applied to the converted monochrome regions. ORD can identify the “medial axis” or backbone of each stroke region. The medial axis is one example of a characteristic axis that can provide a precise, artifact-free representation of the region that also preserves its structure including intersections, corners, or endpoints. The ORD algorithm can produce a uniformly thin medial axis, free from holes and distortions, including branching for complex structures. Branches may refer generally to the longest uninterrupted (e.g., junction free) sequence of points on an identified ridge. Branches can serve as preliminary strokes or rough approximations to the medial axis which represent the skeleton of the structure. Some ORD implementations also can also output stroke width for regions identified as stroke.

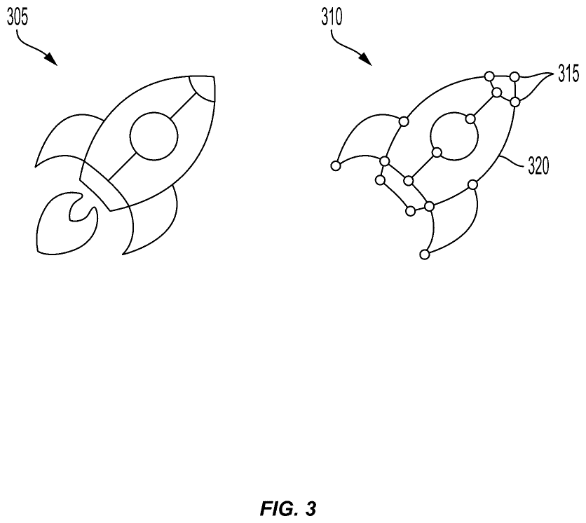

FIG. 3 shows an example of optimal ridge detection, according to some aspects of the present disclosure. An input image 305 is shown on the left panel and a schematic representation 310 of an ORD process as application to input image 350 is shown on the right. ORD is an example of a Euclidean distance transform that can be used for extracting a medial axis (or “ridge”) from vector objects such as strokes or fills in vector graphics. In some examples, input image 305 is first converted to grayscale. Grayscale conversion may be since color variations are often not included in medial axis extraction computations and may therefore increase computational complexity. The input image 305 depicts a received image. The schematic representation 310 depicts a monochrome image of the received image following determination of the regions as described above in block 220 and conversion to grayscale, as well as additional visual aids for illustrative purposes, as described below. In schematic representation 310, black represents the background and white represents the foreground of the converted input image 305.

In some example ORD processes, distance calculations are first performed between pairs of black and white pixels to map the proximity to the nearest black pixel from each white pixel. As a rough approximation, the medial axis can first be identified as the loci of the maximum computed distances. However, this method can introduce inaccuracies, especially at the ends or junctions of strokes, causing inaccurately high distance values to be computed outside the true medial axis. Moreover, naïve application of this method can result in fragmented medial axes or unnecessary pixels included in medial axes.

Some example ORD processes can improve on this rough approximation by initiating a depth-first traversal of the mathematical graph made up of the medial axis pixels thus identified beginning from the maximum computed distance point and selecting connecting pixels based on a probability measure. The probability may represent, for example, how a pixel's value compares to neighboring pixels aligned along a calculated normal to preserve continuity. This approach can mitigate the gaps that result from the rough approximation and can enforce a single-pixel-wide backbone by not including extraneous pixels that would otherwise distort continuity or introduce “zigzags” or rapid turns inconsistent with the shape of the stroke. During the depth-first traversal, pixel neighbors can be prioritized based on continuity concerns to enforce unidirectional flow as the medial axis is traversed. This selective process can maintain a uniform width of the medial axis, reduce erratic direction changes, and yield a clean, thin, and unbroken line.

Following the depth-first traversal, some spurious pixels may still remain that deviate from the true medial axis. Such spurious pixels may commonly be found near junctions, corners or end points. Such pixels can be identified by determining normal vectors to the medial axis and noting deviations from the normal vector to the medial axis at nearby pixel locations. Once identified, the spurious pixels can be filtered from the medial axis or repaired. First, junctions 315 or bifurcations in the medial axis can be identified. Second, a process for “erratic width profile estimation” in the vicinity of junctions can be used to remove parts of the medial axis that exhibit depressions or bulges. Next, the junctions can be recreated by extrapolating parts of the nearby medial axis that bear expected (e.g., non-erratic) width profiles. Finally, the medial axis can be broken into branches at corrected junctions to further simplify processing. The computed medial axis 320 is shown in FIG. 3 as a white outline of the rocket shape.

Continuing with the description of block 230, once a characteristic axis is determined for each region, classifying each region can involve first identifying a centerline or an absence of a centerline for the region. For example, the centerline can be determined by identifying a locus of equidistant points from the region's boundaries, similar to the rough approximation used in optimal ridge detection, as described above. If the characteristic axis is open and within a predetermined minimum threshold distance from the determined centerline of the region, then the region can be classified as a stroke. If the characteristic axis lacks an apparent centerline, as determined using geometric methods, then the region may be classified as a fill. In addition to this example approach, other approaches for classifying the identified regions as strokes or fills may likewise be used.

At block 240, the computing system generates a spatial data structure representing the regions classified as strokes using a characteristic axis of each stroke. For example, the spatial data structure may be an R-tree. An R-tree is a hierarchical data structure optimized for indexing and querying spatial information. An R-tree can organize geometric objects, such as the regions classified as strokes, into nested bounding boxes. Accordingly, the R-tree thus generated can be “queried” to enable spatial searches, proximity queries, and overlap detection. In the R-tree, each region classified as a stroke can be represented by a branch of the characteristic axis, such as the medial axis identified using ORD. A tightly bounded bounding box for the stroke can be identified and added to the R-tree as a quadrilateral approximation of the stroke.

At block 250, the computing system determines one or more pairs of overlapping strokes and fills. Regions classified as fills can be represented using a bounding box around the outer periphery of the fill. The bounding box thus defined can be used to determine input parameters for queries against the R-tree just generated to determine overlaps. To determine the bounding box, for each fill of the one or more pairs of overlapping strokes and fills, a representative outer contour can be determined. The tightest bounding box, defined as one that is tangent to the outer contour at a maximal number of points, can be determined from the outer contour. In some examples, the bounding box can be inflated by a small amount to minimize overlaps missed due to precision or floating-point issues.

The bounding boxes of the fill regions thus determined are used to query the spatial data structure to determine overlapping strokes. For example, if the spatial data structure is an R-tree, the R-tree can be queried by programmatically iterating over the treelike nodes of the R-tree to identify overlaps. In some examples, multiple strokes may be identified that overlap a fill. Thus, each identified pair of overlapping strokes and fill can include multiple strokes.

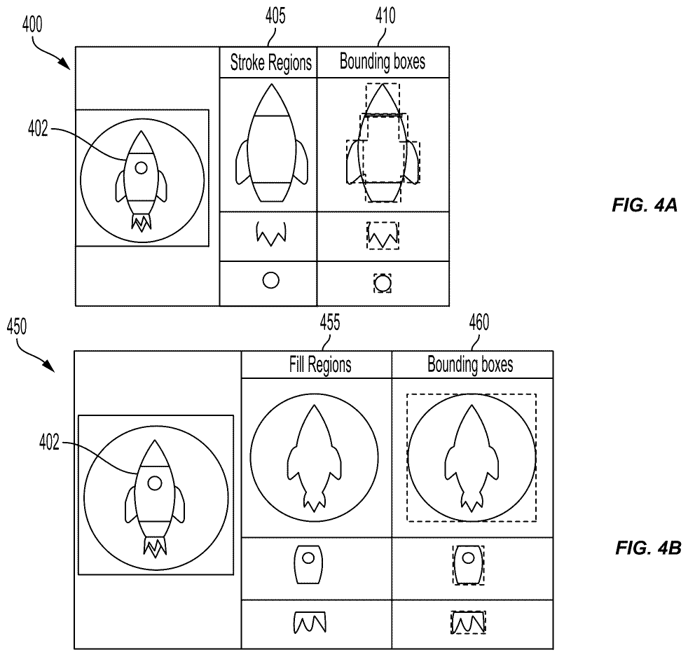

FIGS. 4A and 4B show example schematic representations of bounding boxes around strokes and fills, according to some aspects of the present disclosure. The illustrations 400, 450 depict a rocket 402 with components such as a body, portal, exhaust, and so on. In column 405 of illustration 400, regions classified as strokes are shown. The top row of illustration 400 shows multiple strokes identified for the body of the rocket. While identified strokes correspond to separate entries in the spatial data structure, they are shown together here as several strokes may together be associated with a corresponding fill region in block 260 below. The middle and bottom rows of column 405 show strokes identified for the rocket exhaust and portal, respectively. Column 410 shows the identified stroke regions with associated bounding boxes, as represented in the spatial data structure. Once again, the top row of column 410 shows numerous bounding boxes corresponding to the multiple-stroke rocket body. The middle and bottom rows of column 410 show single bounding boxes around the strokes identified for the rocket exhaust and portal strokes, respectively.

The top, middle, and bottom rows of illustration 450 correspond to the top, middle, and bottom rows of illustration 400, respectively. In column 455 of illustration 450, regions classified as fills are shown. Column 460 of illustration 450 shows bounding boxes drawn around the fills of column 455. In both columns 410 and 460, the bounding boxes shown are only illustrative. In the case of column 410, the bounding boxes are defined in the spatial data structure. In the case of column 460, the bounding boxes may be computed during block 250 and not necessarily persisted.

Some input images may result in regions classified as fills that have not associated overlapping or enclosing stroke. Such regions may be referred to as fill-only regions and consequently are not associated with any stroked in the following block 260. However, such fill-only regions can be layer ordered and output in accordance with blocks 270 and 280 as described below.

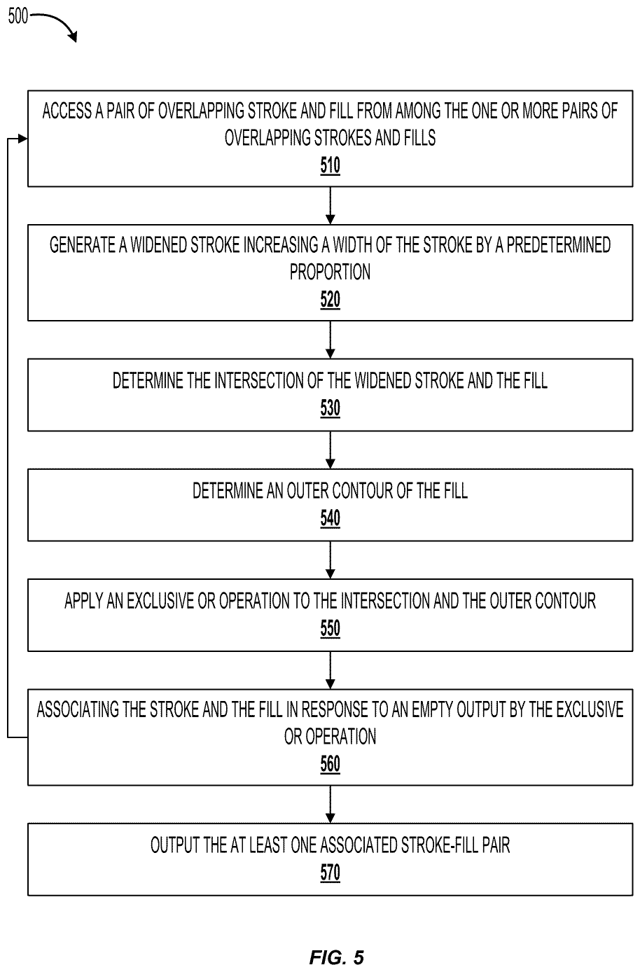

Resuming the description of process 200, at block 260, the computing system identifies, using the one or more pairs of overlapping strokes and fills and the spatial data structure, at least one associated stroke-fill pair. In this block, pairs of overlapping stroke and fills can be associated to develop the structural coherence that is of significant utility to designers. In some examples, various processes can be used to combine fills with their surrounding strokes, which can effectively mimic how a human designer would traditionally enclose filled regions with a stroke by hand. For example, associating fills with their corresponding strokes can be brought about by slightly inflating fill regions and analyzing intersections with overlapping strokes, while replicating shared boundaries as needed. One example approach for associating stroke-fill pairs is described in detail below in FIG. 5.

In some examples, strokes that that appear to enclose more than one fill can be replicated so that such strokes can be associated with more than one fill region. This replication can ensure that shared boundaries do not result in stroke-fill associations that appear incomplete to a designer who desires to modify a boundary element without affecting unrelated parts of the design. For example, once a fill region is associated with one or more strokes as described above and below in FIG. 5, the associated strokes can be marked in the spatial data structure using, for instance, a binary flag in the R-tree. The binary flag can indicate that the one or more strokes have been associated with at least one fill. The one or more strokes can be retained in the spatial data structure so that their overlap with other fills can be identified and potentially subsequently associated with. Such strokes that touch multiple fill regions are replicated and placed atop one another (their layer-or z-ordering is addressed below in block 270). “Stacking” the replicated strokes in this way can cause one stroke to overlap a stroke underneath it, ensuring that the output vector graphic has the same appearance as the input image. This approach also enhances editability since all components can be individually edited. In some examples, stroke replication is only used for strokes that form a complete enclosure around a fill region. For strokes that do not form a complete enclosure around a fill region, the binary flag is not set to prevent stroke replication to ensure that the appearance of the output vector graphic matches the input image.

In some examples, multiple strokes may overlap on a single path to achieve effects such as thick multi-colored (or shaded) borders or layered appearances, such as concentric rings. Such effects can be achieved by layering strokes having different widths and colors. To identify strokes with such an arrangement, the identification of associated stroke-fill pairs as described this block and detailed below in FIG. 5 can be used. In addition to checking for enclosure of fill regions by strokes, enclosure of strokes by other strokes can also be checked. If a full enclosure is found between two strokes that are not derived from different branches, the outer stroke can be combined with the inner stroke (e.g., the outer stroke can be made another stroke of the path formed for the inner stroke.

In some cases, a chain of overlapping strokes may exist. In these cases, chained, overlapping strokes can be ordered in terms of their areas (e.g., bounding box sizes). The queries to determine overlapping regions per block 250 can be performed in increasing order of areas. This ensures that when outer strokes are identified, all inner strokes of the identified outer strokes have already been associated. Accordingly, since such strokes are always fully covered, a usage flag in the spatial data structure, such as the R-tree binary flag, can be set to prevent unnecessary duplication of such strokes. Some overlapping strokes may be open strokes, for which there is no inner or outer boundary, and consequently no associated fill. Such open strokes may be stacked according to the layer ordering procedure described in block 270. For such open strokes, the area of the strokes does not govern their order of processing or association, as described above.

At block 270, the computing system determines a layer ordering of at least one associated stroke-fill pair. Determination of the layer ordering can be performed with reference to the input image. Since the input image is flat (e.g., raster images or bitmaps lack layers) certain heuristics can be used to determine, for overlapping components, which component should feature at the top and which at the bottom. In one example, the layer ordering can be based on selecting an arrangement that does not change the appearance of the input image. For instance, consider several overlapping strokes with a similar extent and length. The stroke with a higher stroke width than the others can be selected to be at a higher layer ordering, ensuring that the stroke that covers the most area of the input image. Consequently, the strokes with a smaller width will be obscured behind the larger one.

Each of the associated stroke-fill pairs can be placed according to the input image's appearance, replicating and layering strokes as needed to ensure that overlaps match the input image's visual relationships. Likewise, paths (e.g., strokes or fills) can be layer ordered such that any replicated or standalone strokes are positioned above regions with full enclosures. Compound paths can be layered relative to their respective background elements. Stroke-only regions can be positioned at the top layer. This z-order arrangement maintains the visual fidelity of the input image while allowing designers to edit any component independently or make global changes (e.g., adjusting stroke weight or color across the entire artwork).

A similar heuristic can be used for overlapping strokes of different colors. In one example, for several overlapping strokes, having a color that most closely matches with the color of the input image at the same location can be selected for a higher layer ordering. In addition to or in lieu of these examples, other heuristics for matching the at least one associated stroke-fill pair to the input image can be used.

At block 280, the computing system generates a vector graphic using the at least one associated stroke-fill pair according to the layer ordering. For example, the associated stroke-fill pair can be combined to form a cohesive vector graphic in accordance with the layer ordering determined in block 270. The output vector graphic format may use any suitable output format including, for example, Scalable Vector Graphics (“SVG”), Encapsulated PostScript (“EPS”), Adobe Illustrator (“AI”), Portable Document Format (“PDF”), and so on.

### Associating Strokes and Fills

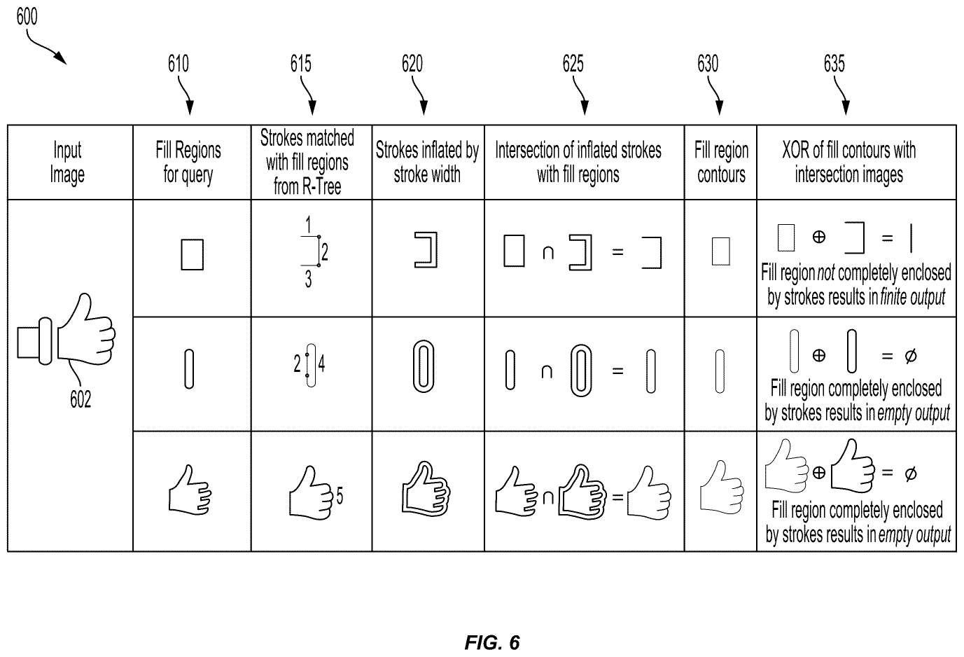

FIG. 5 is a flow diagram of an example process 500 for using the one or more pairs of overlapping strokes and fills and the spatial data structure, at least one associated stroke-fill pair, according to some aspects of the present disclosure. The process 500 depicted in FIG. 5 may be implemented in software executed by one or more processing units of a processing device, implemented in hardware, or implemented as a combination of software and hardware. This process 500 is intended to be illustrative and non-limiting. The example process herein is described with reference to the example vector graphic generation system 100 implementation depicted in FIG. 1, but other implementations are possible. Although FIG. 5 depicts various processing operations occurring in a particular order, the particular order depicted is not required. In certain alternative embodiments, the processing may be performed in a different order, some operations may be performed in parallel, or operations may be added, removed, or combined together. Illustrations of these steps are shown below in FIG. 6.

At block 510, a computing system, such as the vector graphic generation system 100 of FIG. 1, accesses a pair of overlapping strokes and a fill from among the one or more pairs of overlapping strokes and fills. For example, the one or more pairs of overlapping strokes and fills may be included in a data structure such as an array and can be iterated over, one pair at a time, such as the pair of overlapping strokes and a fill of the present block.

At block 520, the computing system generates a widened stroke by increasing a width of the stroke by a predetermined proportion. For example, the determination of the characteristic axis (e.g., using ORD) may involve determining the stroke width as a byproduct. The stroke width can be increased by a predetermined proportion such as by half the stroke width on both sides of the characteristic axis (e.g., the medial axis).

At block 530, the computing system determines the intersection of the widened stroke and the fill. Determining the intersection may involve overlaying the stroke on the fill (or the fill on the stroke) and removing portions of the overlaid stroke-fill pair that are not common to both the stroke and the fill. Following this operation, pixels common to both the stroke and the fill remain.

At block 540, the computing system determines an outer contour of the fill. In some examples, the outer contour determined in block 250 can be used in process 500. Determination of the outer contour of the fill may involve using techniques such as edge detection or boundary tracing algorithms. Such algorithms can map the fill's perimeter by, for example, identifying transition points between the fill and its surrounding area.

At block 550, the computing system applies an exclusive OR operation to the intersection and the outer contour. The exclusive OR operation (sometimes referred to as “XOR”) can be used to test how much of the periphery of the fill region is covered by the intersection determined in block 530. The exclusive OR operation compares the outer contour of the fill region determined in block 540 with the intersection and outputs only portions of the outer contour or intersection that are not common to both. This in effect identifies strokes that fully encapsulate the associated fill region. For example, the computing system can determine how many outer contour pixels remain untouched by the intersection image following the exclusive OR operation. If no outer contour pixels remain, this can be indicative of full coverage of the fill region and an accompanying stroke that wraps the fill region.

At block 560, the computing system associates the strokes and the fill in response to an empty output by the exclusive OR operation. After a complete enclosure is identified, the width of each stroke can be reduced to its original value prior to widening in block 520. In some examples, the width of the several strokes making up a complete enclosure may vary. In this case, the smallest width can be selected and applied to the other strokes in the group to prevent the resulting closed stroke from covering more pixels than in the input image.

In some cases, more than one color are found among the strokes to be associated. In such cases, the color for all the strokes in group can be updated to a single color based on the dominant color found among the strokes in the group. For example, the most frequently recurring color can be selected. Inconsistencies in width and color caused by these actions can be cured when adjusting the layer ordering as described above with respect to block 270 of FIG. 2.

At block 570, the computing system outputs the at least one associated stroke-fill pair. The at least one associated stroke-fill pair can be layer ordered or z-ordered and output according to blocks 270 and 280 above.

FIG. 6 shows illustrations 600 of associating stroke and fill pairs, according to some aspects of the present disclosure. The illustrations 600 depict an input image including a hand 602. In column 610, example regions classified as fills are shown. In column 615, example regions classified as strokes are shown. In particular, the strokes in column 615 are ones identified as overlapping with the bounding boxes of the fills in column 610 as described above in block 250. In column 620, the strokes of column 615 are shown with an inflated width, following application of the operation described above in block 520. Column 625 depicts the intersection applied as between the fills of column 610 and the inflated strokes of column 620, as described in block 530. Column 630 shows the outer contours of the fills of column 610 extracted per the operation described in block 540.

Column 635 shows the XOR operation as applied between the outer contours of column 630 and the intersections of column 625, as described in block 550. In the top row, the closed rectangular outer contour is XOR'ed with the open rectangular intersection. The geometric XOR operation results in a finite output when the two inputs are not the same. In this example, because the outer contour is not completely enclosed by the intersection, one side of the outer contour results, indicating that the stroke and fill should not be associated. In the middle and bottom rows, the closed outer contours are completely enclosed by the corresponding intersections, resulting in no output (denoted as the empty set in FIG. 6), indicating the stroke and fill should be associated.

### Compound Paths

In some examples, one or more compound paths may be identified based on the one or more classified regions. Compound paths can include, for example, associated stroke and fills that include holes which may expose background color or other underlying elements. Compound paths may be identified by checking each identified first region's spatial bounds and examining whether it lies within another region which itself lies within another larger second region but shares the same fill color as the identified first region. If it does, the identified first region is treated as a “hole” within the second region and implemented in the output vector graphic as an even-odd compound path, creating the hole effect. An even-odd compound path refers generally to a geometric fill rule or heuristic used to determine whether a hole should be filled or not. Other compound path implementations may be similarly used. In some cases, several regions may include holes that “see-through” to the same background region. Consequently, compound paths may be composed of two or more paths.

In some examples, a region may include holes that see-through to the background on which the entire input image is apparently placed. In this case, there is no other region containing the region. The constant color background can be treated as a “pseudo region” around the input image. A compound path can then be created that includes holes with respect to the background or pseudo region. Compound paths can be layered using the process described above with respect to block 270 of FIG. 2, consistent with the handling of strokes and fills to maintain consistency with the overall composition.

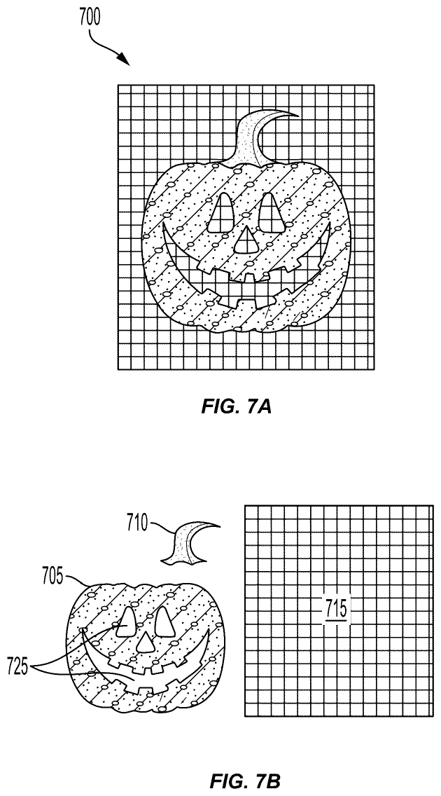

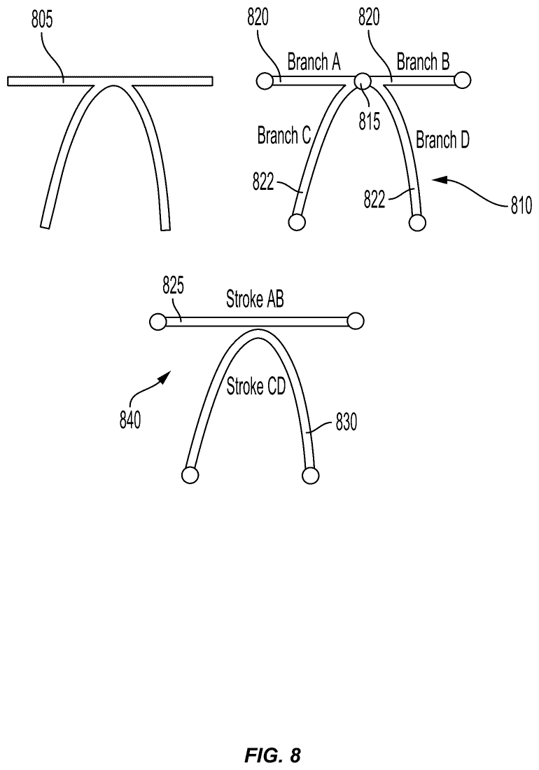

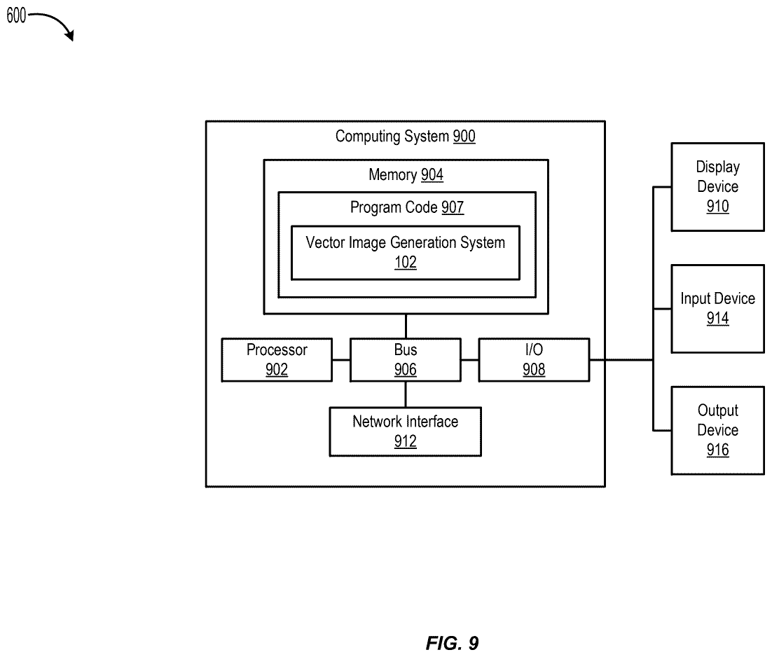

FIGS. 7A-7B show an example of a compound path 705, according to some aspects of the present disclosure. Example compound path 705 is the orange base of the jack-o-lantern found in input image 700, shown in FIG. 7A. The steam 710 of the jack-o-lantern is shown as a stroke or region, processed using the method 200 of FIG. 2. The compound path 705 includes several holes 725, such as the eyes, nose, and mouth of the jack-o-lantern. The holes 725 can be identified by using the method described above. For example, regions identified within the compound path 705 (the regions that “fill” the holes 725) can be determined to be lying within a first region that is identical to the compound path 705, except without the holes 725 (not shown). The first region itself lies within another larger second region 715 that shares the same fill color as the regions filling the holes 725. The identified hole regions can be treated as holes within the first region. An even-odd compound path can be instantiated to create the vector graphic including the compound path 705 with the identified holes 725.

### Leftover Strokes

In some examples, some regions classified as strokes may not overlap with any fills. Accordingly, such identified unassociated strokes are not included among the one or more pairs of overlapping strokes and fills. Such strokes may be open regions (e.g., they do not form a closed loop) since closed regions would have an accompanied identified fill region and would thus be combined with a stroke region block 260 of FIG. 2. Stroke regions that have been associated with one or more fills can be identified using a binary flag in the spatial data structure. In contrast, stroke regions that are either only partially combined with a fill region or not combined with any fill region at all will not have this flag set. For example, some strokes that border multiple fill regions may be replicated, in part or in whole, during the association process of block 260. Similarly, some identified strokes may not have the full width or be the same color as the corresponding regions of the input image, resulting in an unassociated stroke region that is not associated during block 260 as described above. Such identified strokes may likewise not have the binary flag in the spatial data structure set and can be handled as unassociated strokes.

Continuous strokes can be generated based on the unassociated strokes, in which the continuous strokes are generated by maximizing the continuity of one or more combined unassociated strokes. For example, while determining the characteristic axis for the unassociated stroke using a procedure such as ORD, as described in block 230 about, one or more branches may be identified at junctions in the characteristic axis. FIG. 8 shows an example of generating continuous strokes using unassociated strokes, according to some aspects of the present disclosure. The example unassociated stroke 805 is an inverted U-shape below a straight line connected at the base of the U-shape. At 810, a junction 815 and several branches 820, 822 identified while computing the characteristic axis (e.g., while using ORD) are shown.

To generate the continuous strokes, all possible combinations of branches 820, 822 are evaluated. Combinations of branches 820, 822 that have a maximized measure of continuity, such as C¹ continuity, are identified. C¹ continuity can refer generally to curves with continuous first derivatives (e.g., rates of spatial change). This requirement can ensure continuous strokes with smooth transitions and no sharp corners or abrupt changes in slope are identified, in preference to stroked with abrupt bends. In this example, as shown at 840, continuous strokes 825 and 830 are identified using this method. Straight branches 820 are combined across the junction 815 to form a longer stroke 825. Curved, homogeneous branches 822 are combined in preference to abrupt forks at junction 815 to form U-shaped object stroke 830. In some examples, to match the appearance of the input image, continuous strokes identified using this method can be added to the top of the layer ordering to ensure consistency with the input image, above all associated stroke-fill pairs or fill only regions.

### Computing Environment

Any suitable computer system or group of computer systems can be used for performing the operations described herein. For example, FIG. 9 depicts an example of a computer system 900. The depicted example of the computer system 900 includes a processor 902 communicatively coupled to one or more memory devices 904. The processor 902 executes computer-executable program code stored in a memory device 904, accesses information stored in the memory device 904, or both. Examples of the processor 902 include a microprocessor, an application-specific integrated circuit (“ASIC”), a field-programmable gate array (“FPGA”), or any other suitable processing device. The processor 902 can include any number of processing devices, including a single processing device.

The memory device 904 includes any suitable non-transitory computer-readable medium for storing program code 906, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript. In various examples, the memory device 904 can be volatile memory, non-volatile memory, or a combination thereof.

The computer system 900 executes program code 906 that configures the processor 902 to perform one or more of the operations described herein. Examples of the program code 906 include, in various embodiments, the vector image generation system 102 of FIG. 1, which may include any other suitable systems or subsystems that perform one or more operations described herein (e.g., one or more ML models, storage systems, controllers, or function-specific modules). The program code 906 may be resident in the memory device 904 or any suitable computer-readable medium and may be executed by the processor 902 or any other suitable processor.

The processor 902 is an integrated circuit device that can execute the program code 906. The program code 906 can be for executing an operating system, an application system or subsystem, or both. When executed by the processor 902, the instructions cause the processor 902 to perform operations of the program code 906. When being executed by the processor 902, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory devices 904 store the program code 906 that includes one or more datasets described herein. In some embodiments, one or more of data sets are stored in the same memory device (e.g., one of the memory devices 904). In additional or alternative embodiments, one or more of the programs, data sets, models, and functions described herein are stored in different memory devices 904 accessible via a data network. One or more buses 910 are also included in the computer system 900. The buses 910 communicatively couple one or more components of a respective one of the computer system 900.

In some embodiments, the computer system 900 also includes a network interface device 912. The network interface device 912 includes any device or group of devices suitable for establishing a wired or wireless data connection to one or more data networks. Non-limiting examples of the network interface device 912 include an Ethernet network adapter, a modem, and/or the like. The computer system 900 is able to communicate with one or more other computing devices via a data network using the network interface device 912.

The computer system 900 may also include a number of external or internal devices, an input device 914, an output device 916, or other input or output devices. For example, the computer system 900 is shown with one or more input/output (“I/O”) interfaces 908. An I/O interface 908 can receive input from input devices or provide output to output devices. An input device 914 can include any device or group of devices suitable for receiving visual, auditory, or other suitable input that controls or affects the operations of the processor 902. Non-limiting examples of the input device 914 include a touchscreen, a mouse, a keyboard, a microphone, a separate mobile computing device, etc. An output device 916 can include any device or group of devices suitable for providing visual, auditory, or other suitable sensory output. Non-limiting examples of the output device 916 include a touchscreen, a monitor, a speaker, a separate mobile computing device, etc.

Although FIG. 9 depicts the input device 914 and the output device 916 as being local to the computer system 900, other implementations are possible. For instance, in some embodiments, one or more of the input device 914 and the output device 916 can include a remote client-computing device that communicates with computing system 900 via the network interface device 912 using one or more data networks described herein.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computer systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

### General Considerations

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configs. the computer system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Additionally, the use of “based on” is meant to be open and inclusive, in that, a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method performed by one or more processing devices, comprising:
receiving an image;
determining one or more regions of the image;
classifying each region of the one or more regions as a stroke or a fill by determining a characteristic axis of the region;
generating a spatial data structure representing the regions classified as strokes using a characteristic axis of each stroke;
determining one or more pairs of overlapping strokes and fills;
identifying, using the one or more pairs of overlapping strokes and fills and the spatial data structure, at least one associated stroke-fill pair;
determining a layer ordering of the at least one associated stroke-fill pair; and
generating a vector graphic using the at least one associated stroke-fill pair according to the layer ordering.

2. The method of claim 1, wherein the image is generated using a generative artificial intelligence (“AI”) diffusion model.

3. The method of claim 1, wherein determining the characteristic axis of the region comprises:
converting the region to a monochrome color scheme; and
determining the characteristic axis of the region using a Euclidean distance transform.

4. The method of claim 3, wherein the Euclidean distance transform is an optimal ridge detection technique and the characteristic axis of the region is a medial axis of the stroke or fill.

5. The method of claim 1, wherein the spatial data structure is an R-tree.

6. The method of claim 1, wherein determining the one or more pairs of overlapping strokes and fills comprises:
determining a bounding box for each stroke and each fill; and
for each pair of strokes and fills:
determining whether the bounding boxes for the stroke and the fill overlap; and
in response to determining that the bounding boxes for the stroke and the fill overlap, identifying the stroke and the fill as overlapping.

7. The method of claim 1, wherein identifying, using the one or more pairs of overlapping strokes and fills and the spatial data structure, the at least one associated stroke-fill pair comprises:
for each pair of the one or more pairs of overlapping strokes and fills:
generating a widened stroke increasing a width of the stroke by a predetermined proportion;
determining the intersection of the widened stroke and the fill;
determining an outer contour of the fill;
applying an exclusive OR operation to the intersection and the outer contour; and
associating the stroke and the fill in response an empty output by the exclusive OR operation.

8. The method of claim 1, wherein determining the layer ordering of the at least one associated stroke-fill pair comprises:
for a plurality of associated stroke-fill pairs, determining one or more overlapping strokes;
determining the layer ordering of the one or more overlapping strokes based on the width of the one or more overlapping strokes and a color of the one or more overlapping strokes; and
determining the layer ordering of the at least one associated stroke-fill pair based on the layer ordering of the one or more overlapping strokes.

9. The method of claim 1, further comprising:
identifying unassociated strokes not included among the one or more pairs of overlapping strokes and fills;
generating continuous strokes based on the unassociated strokes, wherein the continuous strokes are generated by maximizing the continuity of one or more combined unassociated strokes; and
adding the continuous strokes to the top of the layer ordering.

10. The method of claim 1, further comprising identifying one or more compound paths based on the one or more regions.

11. The method of claim 1, wherein classifying each region of the one or more regions as a stroke or a fill by determining the characteristic axis of the region comprises:
identifying a centerline or an absence of a centerline for the region;
responsive to the characteristic axis being open and within a predetermined minimum threshold distance from the centerline of the region, classify the region as a stroke; and
responsive to the characteristic axis being closed or the absence of the centerline of for the region, classifying the region as a fill.

12. A non-transitory computer-readable storage medium storing processor-executable instructions configured to cause one or more processors to perform:
a step for determining one or more regions of an image;
a step for classifying each region of the one or more regions as a stroke or a fill;
a step for generating a spatial data structure representing the regions classified as strokes using a characteristic axis determined for each stroke;
a step for determining one or more pairs of overlapping strokes and fills;
a step for identifying, using the one or more pairs of overlapping strokes and fills and the spatial data structure, a plurality of associated stroke-fill pairs; and
a step for generating a vector graphic using the plurality of associated stroke-fill pairs.

13. The non-transitory computer-readable storage medium of claim 12, wherein the image is generated using a generative artificial intelligence (“AI”) diffusion model.

14. The non-transitory computer-readable storage medium of claim 12, wherein the step for classifying each region of the one or more regions as a stroke or a fill comprises:
determining a characteristic axis of each region by:
converting the region to a monochrome color scheme; and
determining the characteristic axis of the region using a Euclidean distance transform, wherein the Euclidean distance transform is an optimal ridge detection technique and the characteristic axis of the region is a medial axis of the stroke or fill;
identifying a centerline or an absence of a centerline for the region;
responsive to the characteristic axis being open and within a predetermined minimum threshold distance from the centerline of the region, classify the region as a stroke; and
responsive to the characteristic axis being closed or the absence of the centerline of for the region, classifying the region as a fill.

15. The non-transitory computer-readable storage medium of claim 12, wherein:
the spatial data structure is an R-tree; and
the step for determining the one or more pairs of overlapping strokes and fills comprises:
determining a first bounding box for each stroke using the R-tree;
determining a second bounding box for each fill; and
for each pair of strokes and fills:
determining whether the first bounding box for the stroke and the second bounding box for the fill overlap; and
in response to determining that the first bounding box and the second bounding box for the stroke and the fill, respectively, overlap, identifying the stroke and the fill as overlapping.

16. The non-transitory computer-readable storage medium of claim 12, further comprising determining a layer ordering of the plurality of associated stroke-fill pairs, comprising:
for the plurality of associated stroke-fill pairs, determining one or more overlapping strokes;
determining the layer ordering of the one or more overlapping strokes based on the width of the one or more overlapping strokes and a color of the one or more overlapping strokes; and
determining the layer ordering of the plurality of associated stroke-fill pairs based on the layer ordering of the one or more overlapping strokes.

17. A system comprising:
one or more non-transitory computer-readable media; and
one or more processors communicatively coupled to the one or more non-transitory computer-readable media, the one or more processors configured to execute processor-executable instructions stored in the non-transitory computer-readable media to:
receive a text prompt describing a target vector graphic;
receive a raster image of the target vector graphic from a generative AI diffusion model based on the text prompt;
determine one or more regions of the raster image;
classify each region of the one or more regions as a stroke or a fill by determining a medial axis of the region;
generate a spatial data structure representing the regions classified as strokes using a medial axis of each stroke;
determine one or more pairs of overlapping strokes and fills;
identify, using the one or more pairs of overlapping strokes and fills and the spatial data structure, at least one associated stroke-fill pair;
determine a z-ordering of the at least one associated stroke-fill pair; and
generate a vector graphic using the at least one associated stroke-fill pair according to the z-ordering.

18. The system of claim 17, wherein classifying each region of the one or more regions as a stroke or a fill comprises:
converting the region to a monochrome color scheme;
determining the medial axis of the region using an optimal ridge detection technique;
identifying a centerline or an absence of a centerline for the region;
responsive to the medial axis being open and within a predetermined minimum threshold distance from the centerline of the region, classify the region as a stroke; and
responsive to the medial axis being closed or the absence of the centerline of for the region, classifying the region as a fill.

19. The system of claim 17, wherein determining the z-ordering of the at least one associated stroke-fill pair comprises:
for a plurality of associated stroke-fill pairs, determining one or more overlapping strokes;
determining the layer ordering of the one or more overlapping strokes based on the width of the one or more overlapping strokes and a color of the one or more overlapping strokes; and
determining the layer ordering of the at least one associated stroke-fill pair based on the layer ordering of the one or more overlapping strokes.

20. The system of claim 17, wherein identifying, using the one or more pairs of overlapping strokes and fills and the spatial data structure, the at least one associated stroke-fill pair comprises:
for each pair of the one or more pairs of overlapping strokes and fills:
generating a widened stroke increasing a width of the stroke by a predetermined proportion;
determining the intersection of the widened stroke and the fill;
determining an outer contour of the fill;
applying an exclusive OR operation to the intersection and the outer contour; and
associating the stroke and the fill in response an empty output by the exclusive OR operation.
